(19) United States
(12) Patent Application Publication
(10) Pub. No.: US 2013/0309528 A1
(43) Pub. Date: Nov. 21, 2013

(54) BATTERY PACK

(71) Applicant: SAMSUNG SDI CO., LTD., Yongin-City (KR)

(72) Inventors: In-Soo Park, Yongin-City (KR); Dae-Yon Moon, Yongin-City (KR); Mi-Ae Um, Yongin-City (KR)

(73) Assignee: SAMSUNG SDI CO., LTD., Yongin-City (KR)

(21) Appl. No.: 13/794,146

(22) Filed: Mar. 11, 2013

(30) Foreign Application Priority Data
May 18, 2012 (KR) 10-2012-0052983

(51) Int. Cl. H01M 2/10

(52) U.S. Cl. CPC H01M 2/1022
USPC 429/7; 429/99; 429/96; 427/230

(57) ABSTRACT

A battery pack includes one or more bare cells and a housing accommodating the bare cells. In the battery pack, the housing is includes first and second layers, and the second layer is partially coated on an inner surface of the first layer.

### RELATED APPLICATIONS

This application claims priority to and the benefit of Korean Patent Application No. 10-2012-0052983, filed on May 18, 2012, in the Korean Intellectual Property Office, the entire content of which is incorporated herein by reference.

### BACKGROUND

1. Field

An aspect of the present invention relates to a battery pack, and more particularly, to a battery pack that is small in size and light in weight.

2. Description of the Related Art

The shape of a secondary battery used can be freely changed depending on the external device in which the secondary battery is used. Since the secondary battery can effectively accumulate energy given its volume and mass, the secondary battery is frequently used as a power source for portable electronic devices.

For example, when an external device requires a power source for high power consumption, a battery pack configured with a plurality of secondary batteries can be commercialized as the power source.

The battery pack configured as described above may include at least one case in which the secondary batteries can be accommodated. In this case, the shape of the case may be variously implemented by an external device in which the battery pack is used.

### SUMMARY

Embodiments provide a battery pack that is small in size and light in weight by applying a new housing thereto.

Embodiments also provide a battery pack having improved production efficiency by simplifying its manufacturing process.

According to an aspect of the present invention, there is provided a battery pack including: one or more bare cells; and a housing accommodating the bare cells, wherein the housing comprises first and second layers, and the second layer is partially coated on an inner surface of the first layer.

The housing may be provided so that at least one portion of the first layer comes in contact with the bare cells.

The housing may include a first facing portion at which the first layer and the bare cell come in contact with each other and a second facing portion at which the second layer and the bare cell come in contact with each other, and the thickness of the first facing portion may be formed thinner than that of the second facing portion.

The first layer may be provided to correspond to the bare cells accommodated in the housing.

The first layer may include a film and the second layer may include resin.

The bare cells may constitute first and second bundles each having one or more bare cells electrically connected therein. The second bundle may be provided at one side of the first bundle, and a protection circuit module may be provided at the other side of the first bundle.

A space portion may be provided between the first and second bundles, and the second layer may be provided in the space portion so as to have a shape corresponding to the space portion.

The housing may further include an adhesive member provided at a portion coming in contact with the bare cell.

The adhesive member may include at least one of double-faced tape, silicon and epoxy.

The housing may further include a recess indented inward from an outer surface of the housing.

The first layer may include an in-mold film (IMF) molded to correspond to the shape of the bare cells.

The second layer may include at least one of polycarbonate (PC), polyethylene (PE) and polyethylene terephthalate (PET).

The first layer may include upper and lower layers with the bare cells interposed therebetween, and the upper and lower layers may be formed of different materials from each other.

As described above, according to the present invention, it is possible to provide a battery pack that is small in size and light in weight by applying a new housing thereto.

Further, it is possible to provide a battery pack having improved production efficiency by simplifying its manufacturing process.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a perspective view of a battery pack according to an embodiment of the present invention.

FIG. 2A is a perspective view of bare cells accommodated in the battery pack.

FIG. 2B is a flowchart illustrating a manufacturing method of a first layer of a housing.

FIG. 3A is a sectional view taken along line A-A of FIG. 1.

FIG. 3B is a schematic view of FIG. 3A.

FIG. 4 is a perspective view showing an end portion of a battery pack according to another embodiment of the present invention.

FIG. 5 is a perspective view showing an end portion of a battery pack according to still another embodiment of the present invention.

FIG. 6A is a perspective view of a battery pack according to still another embodiment of the present invention.

FIG. 6B is a sectional view taken along line B-B of FIG. 6A.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals refer to like elements.

Hereinafter, exemplary embodiments of the present invention will be described with the accompanying drawings.

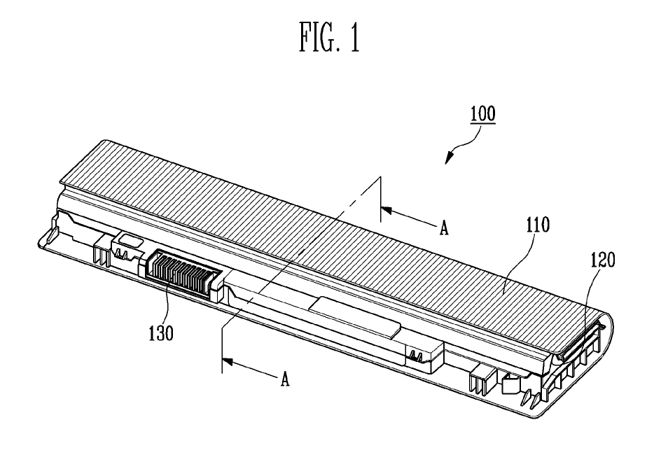

FIG. 1 is a perspective view of a battery pack according to an embodiment of the present invention.

The battery pack 100 according to this embodiment includes one or more bare cells 10, and a housing 110 and 120 accommodating the bare cells 10. The housing 110 and 120 includes first and second layers 110 and 120, and the second layer 120 is partially coated on an inner surface of the first layer 110.

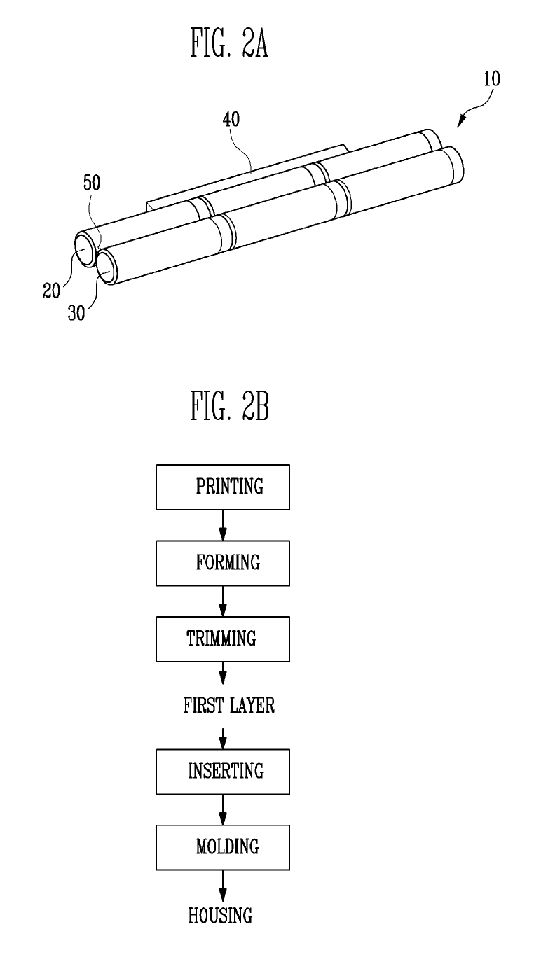

FIG. 2A is a perspective view of bare cells accommodated in the battery pack. FIG. 2B is a flowchart illustrating a manufacturing method of a first layer of a housing.

Referring to FIGS. 1 and 2A, the battery pack 100 may include the housing 110 and 120, and the bare cells 10, a protection circuit module 40 and a connector 130, which are provided in the housing 110 and 120.

The bare cell 10 includes a lithium secondary battery capable of being charged/discharged, and may be used as a power source of an electronic device by transferring electrochemical energy generated in the bare cells 10 to the outside of the battery pack 100. The bare cell 10 may be divided into a cylinder-type, prism-type or pouch-type bare cell according to the external shape thereof. In this embodiment, the bare cells 10 may include cylinder-type bare cells connected in parallel or series, and may be variously modified according to the battery pack 100.

The protection circuit module 40 may control the charging/discharging state, current, voltage or temperature of the bare cells 10. The connector 130 may be provided to face the outside at a side of the housing 110 and 120. The connector 130 is exposed to the outside through the housing 110 and 120 and connected to the electronic device so as to become a path along which power is supplied to the electronic device.

Referring to FIGS. 1 and 2B, the housing 110 and 120 includes the first and second layers 110 and 120, and the second layer 120 may be partially coated on the inner surface of the first layer 110.

The first layer 110 may be provided to correspond to the bare cells 10 accommodated in the housing 110 and 120. For example, the first layer may include a film and the second layer may include resin. In this case, the first layer 110 may include an in-mold film (IMF) molded to correspond to the shape of the bare cells 10.

As portable electronic devices are developed, battery packs require miniaturization and slimming, and various external appearances according to electronic devices. The present invention relates to a miniaturized and slimmed battery pack of which external appearance can be easily changed. The battery pack has a simplified manufacturing process, thereby improving production efficiency.

Typically, the housing of the battery pack is provided using a general resin finishing method, but there is a limitation in controlling the thickness of the housing using the resin finishing method. Since the shape of the housing cannot be finely controlled using the resin finishing method, the design of the external appearance of the battery pack may be restricted by the resin finishing method.

On the other hand, the housing of the battery pack according to this embodiment may be manufactured using an IMF method. The IMF method has excellent printability, so that it is possible to easily implement a beautiful design of the battery pack and to have excellent safety against heat. Thus, the battery pack has less warping phenomenon in its manufacturing or completing process, thereby improving safety.

The manufacturing method of the housing 110 and 120 according to this embodiment may include a printing process, a forming process, a trimming process, an inserting process and a molding process by applying an IMF method thereto.

The printing process is a process of printing a desired pattern on a predetermined film, and the film on which the printing process has been performed may be manufactured into the first layer 110 through the forming and trimming processes. Subsequently, the second layer 120 may be coated on the first layer 110 through the inserting and molding processes. In this case the second layer 120 may include at least one of polycarbonate (PC), polyethylene (PE) and polyethylene terephthalate (PET). According to the manufacturing method described above, the housing 110 and 120 may be manufactured, which includes the first layer 110 implemented, for example, as an IMF, and the second layer 120 partially coated on the inner surface of the first layer 110. As such, the housing 110 and 120 manufactured using the IMF method can be slimmed and miniaturized, and the implementation and modification of a complicated external appearance, etc. can be more easily performed.

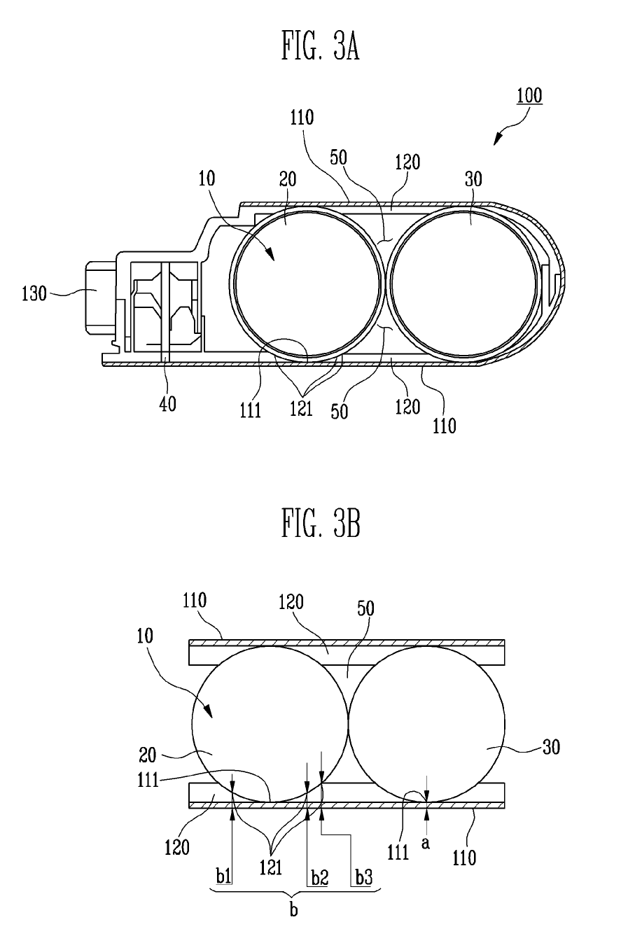

FIG. 3A is a sectional view taken along line A-A of FIG. 1. FIG. 3B is a schematic view of FIG. 3A.

Referring to FIGS. 3A and 3B, the housing 110 and 120 constituting the battery pack 100 according to this embodiment may be provided so that at least one portion of the first layer 110 comes in contact with the bare cells. The housing 110 and 120 may include a first facing portion 111 at which the first layer 110 and the bare cell 10 come in contact with each other, and second facing portions 121 at which the second layer 120 and the bare cell 10 come in contact with each other.

The housing 110 and 120 includes the first and second layers 110 and 120. The first layer 110 is a basic frame, and may be provided as an outer surface of the housing 110 and 120. The second layer 120 is coated at a predetermined portion on the inner surface of the first layer 110, so that the strength of the housing 110 and 120, the internal shape of the housing 110 and 120, and the like can be variously modified. The area in which the second layer 120 is coated may be freely adjusted. In the battery pack 100 according to this embodiment, a thick portion of the bare cell 10 is provided to come in contact with the first layer 100, so that the miniaturization and slimming of the battery pack can be more easily implemented.

The thickness ‘a’ of the first facing portion 111 may be formed thinner than the thickness ‘b’ of the second facing portion 121. The first facing portion 111 is a portion provided so that the first layer 110 and the bare cell 10 directly face each other, and the thickness ‘a’ of the first facing portion 111 is influenced by only the thickness of the first layer 110. On the other hand, the thickness ‘b’ of the second facing portion 121 may be a thickness including both the first and second layers 110 and 120. For example, while the first layer 110 has a constant thickness regardless of the external appearance of the bare cell 10, the second layer 120 may be molded with resin or the like according to the shape of the bare cell 10. Therefore, the thickness ‘b’ of the second facing portion 121, which is a thickness including both the first and second layers 110 and 120, may be implemented as various thicknesses ‘b1,’ ‘b2’ and ‘b3’ of the second facing portion 121, and each of the thicknesses ‘b1,’ ‘b2’ and ‘b3’ of the second facing portion 121, which are variously implemented, may be formed thicker than the thickness ‘a’ of the first facing portion 111.

The bare cells 10 constitute first and second bundles 20 and 30 (See FIG. 2A) each having one or more bare cells electrically connected therein. The second bundle 30 may be provided at one side of the first bundle 20, and the protection circuit module 40 may be provided at the other side of the first bundle 20. The bare cell 10 may be formed in a cylindrical shape, and a space portion 50 is provided between the first and second bundles 20 and 30 according to the structural characteristic of the external appearance of the bare cell 10. The second layer 120 may be formed in the shape corresponding to the space portion 50.

Since the second layer 120 may be variously provided according to the external appearance of the bare cell 10, the second layer 120 may fill in the space portion 50 formed according to the arrangement of the first and second bundles 20 and 30 configured with the bare cells 10. Thus, the bare cells 10 can be firmly fixed by the second layer 120 in the battery pack 100, and the battery pack 100 can prevent the bare cells 10 from being moved by an external impact.

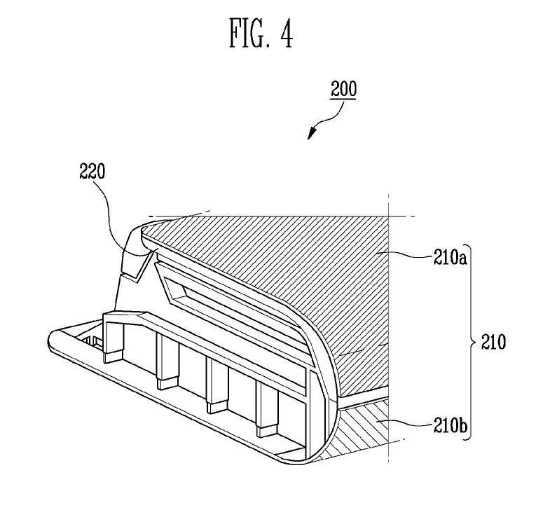

Hereinafter, other embodiments of the present invention will be described with reference to FIGS. 4 to 6B. Contents of these embodiments, except the following contents, are similar to those of the embodiment described with reference to FIGS. 1 to 3B, and therefore, their detailed descriptions will be omitted.

FIG. 4 is a perspective view showing an end portion of a battery pack according to another embodiment of the present invention.

Referring to FIG. 4, the battery pack 200 according to this embodiment includes one or more bare cells and a housing 210 and 220 accommodating the bare cells. The housing 210 and 220 may include a first layer 210 and a second layer 220 partially coated on the first layer 210. The first layer 210 is divided into upper and lower layers 210a and 210b with the bare cells interposed therebetween, and the upper and lower layers 210a and 210b may be formed of different materials from each other.

In the housing 210 and 220 capable of being manufactured using the IMF technique or the like, the upper and lower portions of the first layer 210 constituting an outer surface of the housing 210 and 220 may be provided using different materials from each other. The upper and lower layers 210a and 210b constituting the first layer 210 may require different characteristics from each other according to their positions and functions. In this case, the battery pack 200 according to this embodiment may have the first layer 210 provided using appropriate materials suitable for the upper and lower layers 210a and 210b, in consideration of the characteristics of the upper and lower layers 210a and 210b. Thus, since the design of the housing 210 and 220 can be easily modified, it is possible to improve the production efficiency of the battery pack 200.

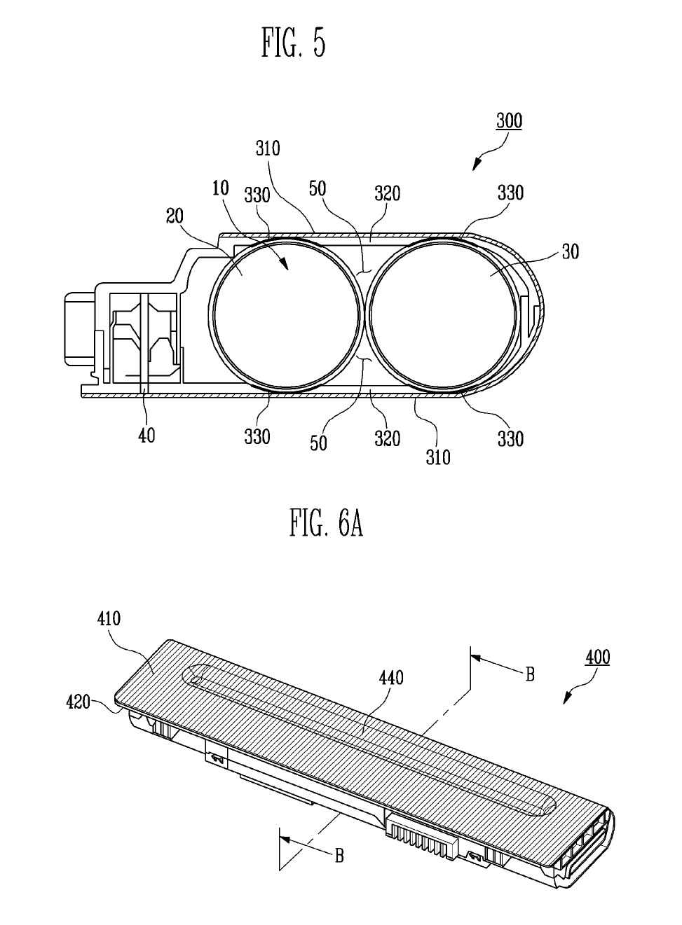

FIG. 5 is a perspective view showing an end portion of a battery pack according to still another embodiment of the present invention.

Referring to FIG. 5, in the battery pack 300 including one or more bare cells 10 and the housing 310 and 320 accommodating the bare cells, the housing 310 and 320 may further include an adhesive member 330 provided at a portion coming in contact with the bare cell 10.

The housing 310 and 320 may include a first layer 310 and a second layer 320 partially coated on the inner surface of the first layer 310. Here, the first and second layers 310 and 320 are integrally formed. The second layer 320 may be formed in a shape corresponding to the bare cells 10 so that the bare cells 10 can be firmly fixed. The first layer 310 may be provided to come in direct contact with the bare cell 10 at a portion at which the second layer 320 is not provided. In this case, the first and second layers 310 and 320 may further include the adhesive member 330 provided at the portion at which the first and second layers 310 and 320 face the bare cell 10. For example, the adhesive member 330 may include at least one of double-faced tape, silicon and epoxy. The adhesive member 330 is provided at the portion at which the first and second layers 310 and 320 face the bare cell 10, so that the bare cells 10 can be further firmly fixed in the housing 310 and 320, thereby improving the safety of the battery pack 300.

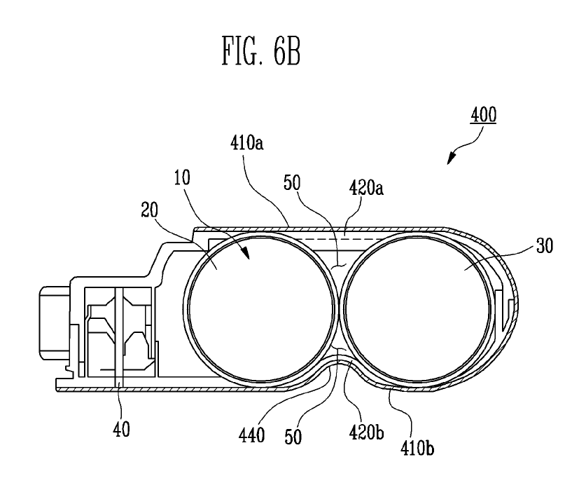

FIG. 6A is a perspective view of a battery pack according to still another embodiment of the present invention. FIG. 6B is a sectional view taken along line B-B of FIG. 6A.

Referring to FIGS. 6A and 6B, the battery pack 400 according to this embodiment includes one or more bare cells 10 and a housing 410 and 420 accommodating the bare cells 10. The housing 410 and 420 may include a first layer 410 and a second layer 420 partially coated on the first layer 410. The housing 410 and 420 may further include a recess 440 indented inward from an outer surface of the housing 410 and 420.

The recess 440 is formed in a shape corresponding to the space portion 50 provided between the first and second bundles 20 and 30, so that the bare cells 10 accommodated in the housing 410 and 420 can be firmly fixed. Accordingly, the recess 440 can share the function of the second layer 420, and thus it is possible to decrease the amount of the second layer 420 filled in the space portion 50.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A battery pack comprising:
one or more bare cells; and
a housing accommodating the bare cells,
wherein the housing comprises first and second layers, and the second layer is partially coated on an inner surface of the first layer.

2. The battery pack according to claim 1, wherein the housing is provided so that at least one portion of the first layer comes in contact with the bare cells.

3. The battery pack according to claim 2, wherein the housing comprises a first facing portion at which the first layer and the bare cell come in contact with each other and a second facing portion at which the second layer and the bare cell come in contact with each other, and the thickness of the first facing portion is formed thinner than that of the second facing portion.

4. The battery pack according to claim 1, wherein the first layer is provided to correspond to the bare cells accommodated in the housing.

5. The battery pack according to claim 1, wherein the first layer includes a film and the second layer includes a resin.

6. The battery pack according to claim 1, wherein the bare cells constitute first and second bundles each having one or more bare cells electrically connected therein, and the second bundle is provided at one side of the first bundle and a protection circuit module is provided at the other side of the first bundle.

7. The battery pack according to claim 6, wherein a space portion is provided between the first and second bundles, and the second layer is provided in the space portion so as to have a shape corresponding to the space portion.

8. The battery pack according to claim 1, wherein the housing further comprises an adhesive member provided at a portion coming in contact with the bare cell.

9. The battery pack according to claim 8, wherein the adhesive member includes at least one of double-faced tape, silicon and epoxy.

10. The battery pack according to claim 1, wherein the housing further comprises a recess indented inward from an outer surface of the housing.

11. The battery pack according to claim 1, wherein the first layer includes an in-mold film (IMF) molded to correspond to the shape of the bare cells.

12. The battery pack according to claim 1, wherein the second layer includes at least one of polycarbonate (PC), polyethylene (PE) and polyethylene terephthalate (PET).

13. The battery pack according to claim 1, wherein the first layer comprises upper and lower layers with the bare cells interposed therebetween, and the upper and lower layers are formed of different materials from each other.

14. A battery pack comprising:
at least one bare cell having an outer surface that defines a contour;
a housing that accommodates the at least one bare cell wherein the housing has a first outer layer and a second inner layer that is at least partially coated on the first outer layer, wherein the second layer is formed so as to match the contour of the outer surface of the bare cell and wherein a portion of the first outer layer is exposed so as to be proximate the outer surface of the bare cell.

15. The battery pack of claim 14, wherein the first outer layer comprises a film and the second inner layer comprises a coating.

16. The battery pack of claim 14, wherein the housing further comprises an adhesive member provided at the exposed portion of the first outer layer.

17. The battery pack of claim 14, wherein the housing defines a recess that extends inward and matches the contour of the at least one bare cell.

18. A method of manufacturing a battery pack housing to house at least one bare cell, the method comprising:
forming a housing with a first layer so as to define a recess that receives the at least one bare cell;
coating an inner surface of the first layer with a second layer wherein the coating is formed so as to conform to the contour of the bare cell and so that at least a portion of the first layer is exposed so as to be proximate the outer surface of the bare cell.

19. The method of claim 18, wherein the first layer comprises a film and the second layer comprises a coating.

20. The method of claim 19, wherein the first layer comprises an in-mold film (IMF).
